(19) United States
(12) Patent Application Publication
(10) Pub. No.: US 2012/0008962 A1
(43) Pub. Date: Jan. 12, 2012

(54) CONTROLLER FOR OPTICAL TRANSCEIVER AND A METHOD TO CONTROL THE SAME

(75) Inventor: Hiromi Tanaka, Yokohama-shi (JP)

(73) Assignee: SUMITOMO ELECTRIC DEVICE INNOVATIONS, INC., Yokohama-shi (JP)

(21) Appl. No.: 12/833,375

(22) Filed: Jul. 9, 2010

(51) Int. Cl. H04B 10/00

(52) U.S. Cl. 398/135

(57) ABSTRACT

A method is disclosed, where the access time to the extended memory space may be shortened in an optical transceiver coupled with a host device through I²C bus. The optical transceiver may respond to extra slave addresses in addition to the base slave address which is normally defined only in a state where the security level is in “privileged level”. The extra slave address is assigned to other devices participated in the I²C bus, but in the production or in the delivery inspection of the transceiver, the extra slave address may be assigned only to the target optical transceiver.

### BACKGROUND OF THE INVENTION

1. Field of the Invention

The present invention relates to a controller for a pluggable optical transceiver and a method to control the same.

2. Related Prior Art

An optical transceiver 10 typically comprises of a transmitter optical subassembly (TOSA) 18, a receiver optical subassembly (ROSA) 19, a transceiver IC 12 and so on. The transceiver IC 12 may include a laser diode driver (LDD) 14 to driver a laser diode (LD) implemented in the TOSA 18, a limiting amplifier (LIA) 15 to amplify a faint signal output from a photodiode (PD) in the ROSA 19, a controller 1, and so on. The controller 1 may store operational parameters of the LDD 14 and the LIA 15, threshold levels for various monitored parameters, and so on to operate various units in the optical transceiver 10 under a control of the host device 20 through the I²C bus 30. The controller 16 provides a memory with a preset address space which may be coupled with the host device 20 also through the I²C bus 30. The memory in the controller 1 may couple with a type of unvolatile memory such as EEPROM (Electrically Erasable Programmable Read Only Memory) or a set of registers. FIG. 2 shows a typical memory map implemented within a conventional optical transceiver. The controller 1 coupled with the I²C bus 30 is assigned A0h and A2h in the slave address thereof by a standard in the field of the optical transceiver. When a master device, the host device 20 shown in FIG. 1, sets A0h for the slave address, the master device may access the address space M50, while, the A2h is set for the slave address, the master device may access the address space M52.

The address space M52 corresponding to the slave address of A2h has three vendor rewritable areas, MA1 to MA3, in addition to a user rewritable area MA0. These vendor rewritable areas, MA1 to MA3, are prepared for storing data of various preset constants, parameters, correction factors and so on, which are primarily utilized in a production and a delivery inspection of the optical transceiver 10; accordingly, these vendor rewritable areas should be locked for users. The access for the vendor rewritable areas, MA0 to MA3, may be performed by presetting an index data of one of 01h to 04h in the index table TB of the base block in the space M52. Moreover, the controller 1 may be configured enable the access to the vendor rewritable areas, MA1 to MA3, only when a preset password is set in the area PW. The index access mode for the memory described above, which equivalently expands the memory space to be utilized, is well known in the field. A Japanese Patent Application published as JP-2006-191681A has disclosed such an access mode.

In the index mode access, it is inevitable to preset the index data in the table TB, which forces the host device to rewrite the table TB when the area to be accessed is changed. The present invention has disclosed a controller to shorten the access time when different memory blocks are alternately accessed.

### SUMMARY OF THE INVENTION

One aspect of the present invention relates to a pluggable optical transceiver that communicates with a host device through a serial interface. The optical transceiver comprises a TOSA, a ROSA, a transceiver circuit includes a driver to drive the TOSA, a limiting amplifier to amplify a signal provided from the ROSA, and a controller to control and monitor the transceiver circuit, the TOSA and the ROSA. The controller includes the serial interface, a memory having a base block and an extended block, and a CPU. A feature of the present optical transceiver is that the controller has a first security level and a second security level; and the extended block of the memory is accessible only in the second security level.

The memory provides a password area allocated in the base block, and the optical transceiver may change the security level thereof when the password area is rewritten. The serial interface may reflect the protocol of the I²C bus. The base block of the memory may correspond to one of slave addressed of the I²C bus that is inherently assigned to the optical transceiver, while, the extended block of the memory may correspond to the other slave address ordinarily not assigned to the optical transceiver. That is, the optical transceiver may respond to the other slave address only when the transceiver is in the second security level. The extended block of the memory may store data used only in a production and a delivery inspection of the optical transceiver.

Another aspect of the invention relates to a method to produce a pluggable optical transceiver that includes a controller with a serial interface and a memory therein. The serial interface communicates with a serial bus. The method includes steps of: sequentially setting on the serial bus a slave address that is inherently assigned to the optical transceiver, a specific memory address that is allocated in a base block of the memory, and a data to be rewritten in the memory address; changing a security level of the optical transceiver from an unprivileged level to a privileged level by rewriting the data in the specific memory address; and sequentially setting on the serial bus another slave address not inherently assigned to the optical transceiver, another memory address allocated in an extended block of the memory, another set of data to be rewritten in the other memory address. A feature of the method is the other set of data is used in the production of the optical transceiver.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a typical block diagram of an optical transceiver according to an embodiment of the present invention, where the transceiver is coupled with the host device through the I²C bus;

FIG. 2 shows a typical memory map implemented in an conventional optical transceiver;

FIG. 3 typically shows a functional block diagram of the controller installed in the optical transceiver according to the embodiment of the invention;

FIG. 4 shows a memory map implemented in “unprivileged level” of the optical transceiver;

FIG. 5 shows a memory map implemented in “privileged level” of the optical transceiver;

FIG. 6 is a flow chart showing a handshake protocol of the I²C bus between the optical transceiver and the host device in both “unprivileged level” and “privileged level”;

FIG. 7A schematically shows a configuration where the optical transceiver is in practical use in the field, while, FIG. 7B shows a configuration where the optical transceiver is in the production or in the delivery inspection;

FIG. 8 shows sequences of the handshake protocol with the host device of the optical transceiver according to the embodiment of the invention; and

FIG. 9 compares the protocol of the conventional optical transceiver with the protocol of the present optical transceiver.

### DETAILED DESCRIPTION OF PREFERRED EMBODIMENTS

Next, preferred embodiments according to the present invention will be described as referring to accompanying drawings. In the description of the drawings, the same element will be referred by the same numeral or the symbol without overlapping explanations.

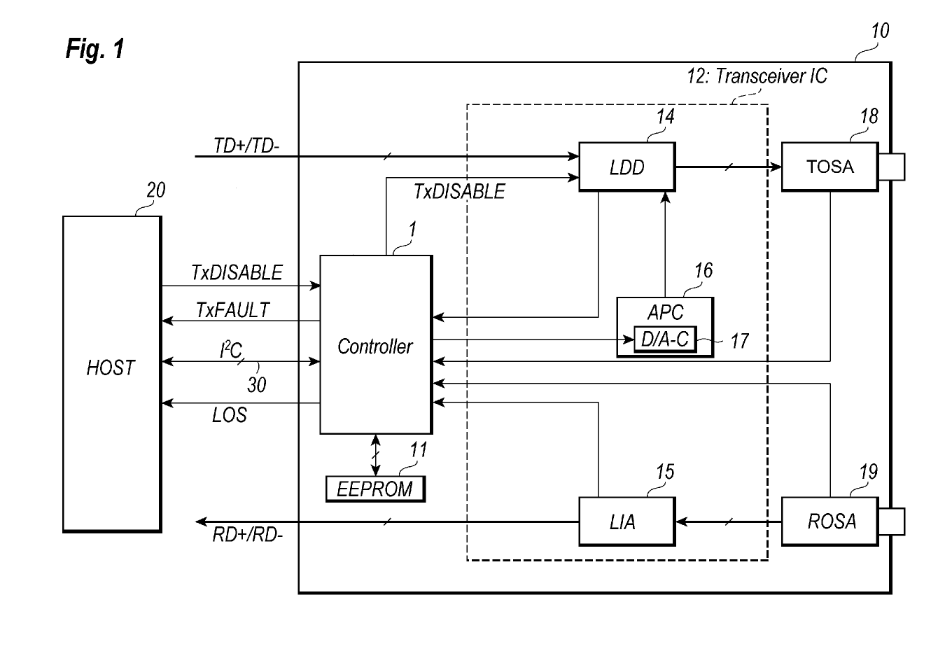

Referring to FIG. 1 again, the controller 1 is operated under the control of the host device 20. Specifically, the controller 1 transmits a signal TxDISABLE provided from the host device 20 to the LD-Driver (LDD) 14 in the transceiver IC 12 to stop the operation of the LDD 14. The controller 1 also transmits another signal TxFAULT to the host device 20, which indicates that the LD in the TOSA 18 is unable to emit light. These signals, TxDISABLE and TxFAULT, in the function thereof obey the standard set in the field of the optical transceiver. Details of the functions that the controller 1 inevitably provides will be described later.

The transceiver IC includes the LDD 14, a limiting amplifier (LIA) 15, an automatic power control (APC) unit 16, and so on. These circuits and units are integrated on a single chip. The controller 1 may control and monitor the operation of the LDD 14, the LIA 15, and the APC 16. The controller 1 may provide control parameters for the LDD 14, the LIA 15, and the APC 16; and may include digital-to-analog converters (D/A-C) and analog-to-digital converters (A/D-C) to acquire operation parameters of the transceiver such as an inner temperature, a power supply voltage, magnitudes of bias and modulation currents provided to the LD, the optical output power emitted from the LD, and the optical power received by the PD. The controller 1 may transmit the status signal LOS to the host device 20. Those parameters and the signals obey the standard ordinarily applied to the optical transceiver.

The TOSA 18 is a type of an optical sub-assembly that includes an LD, while, the ROSA 20 is another type of an optical sub-assembly that includes a PD. The LDD 14 may drive the LD implemented within the TOSA 18 based on the signal TD+/TD− of the differential mode which is externally provided; while, the LIA 15 may process the signal coming from the PD in the ROSA 19 and externally transmit the signal RD+/RD− of the differential mode. The APC 16 may keep the optical output power of the LD in constant, which includes the D/A-C 17 that sets a target power of the LD to the APC unit 16. The host device 20 is a type of a controller installed in the Upper level of the optical transceiver 10. The host device 20 may be a type of field programmable gate array (FPGA).

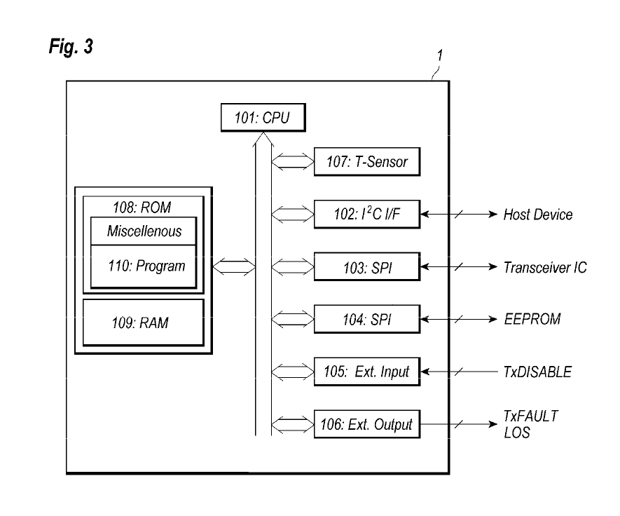

Next, the function of the controller 1 will be described. FIG. 3 exemplarily illustrates the functional block diagram of the controller 1 where the controller 1 comprises a central processing unit (CPU) 101, a memory block that includes a read only memory (ROM) 108 and a random access memory (RAM) 109, a plurality of peripheral interfaces, 102 to 106, and a temperature sensor 107. The ROM 108 provides two address spaces, one of which is for storing the program to operate the controller 1. The controller 1 may execute the program stored therein to achieve functions of the controller 1 described above.

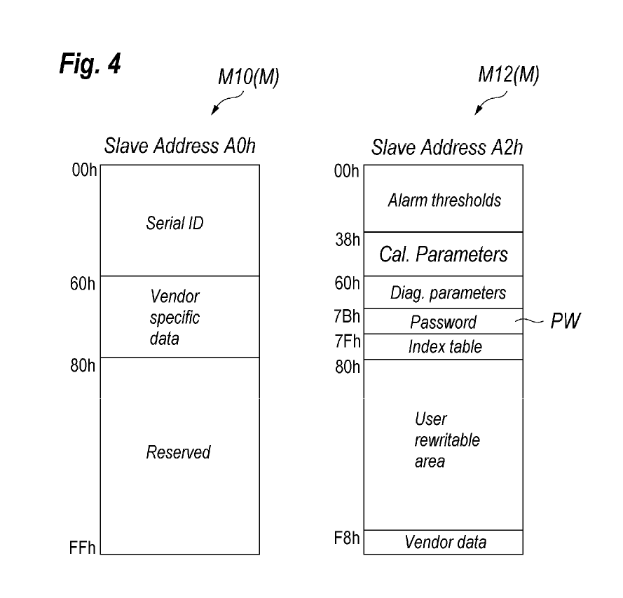

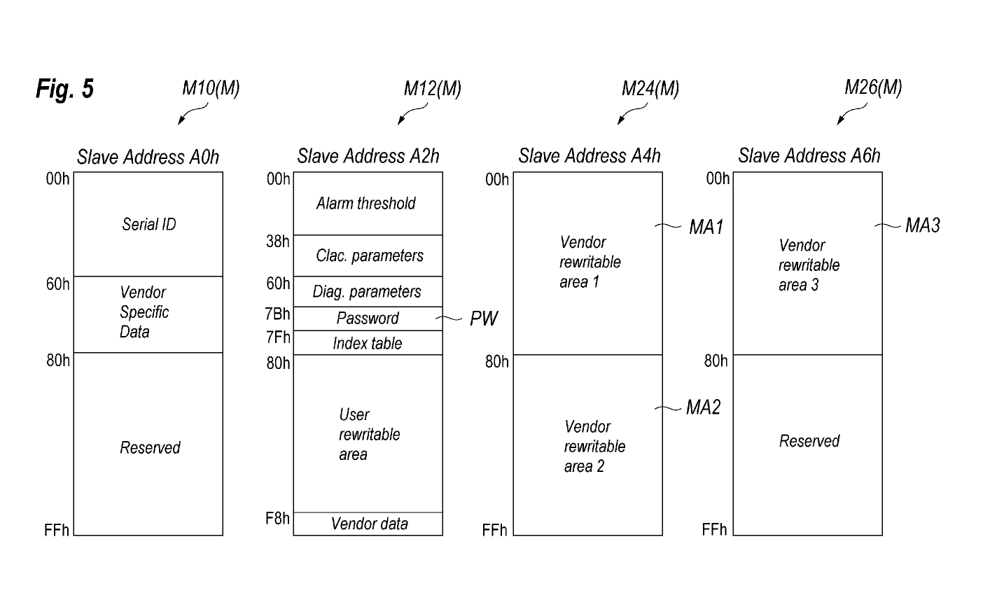

FIGS. 4 and 5 show examples of the memory map M, which may be reflected in the EEPRM 11, in registers implemented within the controller 1 (not shown in figures), or in the RAM 109 illustrated in FIG. 3. Details of the memory map M will be described later. The CPU 101 may select one of the blocks, M10 and M12, shown in FIG. 4, or M10 to M26 shown in FIG. 5 based on the security level determined by the CPU 101. The security level may be distinguishable in two modes of “unprivileged level” and “privileged level”. When the CPU 101 sets the security level thereof to be “unprivileged level”, only two blocks, M10 and M12, are accessible by the CPU 101; while, when the “privileged level” is set, then the CPU 101 may access other two blocks, M24 and M26, in addition to the base blocks, M10 and M12.

The I²C interface 102, which is coupled with the I²C bus 30 and receives the memory address from the host device 20 by replying the ACK when the received memory address coincides with the predetermined slave address inherent to the target optical transceiver 10.

The CPU 101 receives a password from the host device 20 through the I²C bus 30 and the I²C interface 102, and compares thus received password with the preset password which stored in the password area PW of the base block M12. When the received password is identical with the preset password, the CPU 101 changes the security level thereof to be “privileged level”; while, the received password is different from the preset one, which corresponds to a case where the host device 20 is operated by someone except for the vendor, the CPU 101 maintains the security level to be “unprivileged level”. The “privileged level” is equivalent to a state where the memory blocks are extended.

The operations mentioned above done by the controller 1, that is, the reception of the password from the host device 20 and the comparison of thus received password with the preset one stored in the password area PW of the base block M12 may be carried out at the initialization of the optical transceiver 10, by a preset interval, or synchronous with a procedure that the preset password is to be rewritten. The CPU 101 may access the EEPROM 11 through the SPI 104. Next, the operation of the SPI 104 and the access of the EEPROM 11 through the SPI 104 in two security levels, and the memory map M reflected in the EEPROM 11 shown in FIGS. 4 and 5 will be described.

When the CPU 101 receives the slave address A0h or A2h from the host device 20 at the security level of “unprivileged level”, the controller 1 first sends ACK to the host device 20 through the I²C bus 30, and subsequently receives the specific memory address following to the slave address. When the slave address is A0h, the controller 1 accesses the block M10 of the EEPROM 11 where the serial ID of the optical transceiver 10, vendor specific data and so on are stored. Half of the block M10 is reserved for the future use. On the other hand, when the slave address is A2h, the controller 1 accesses the other base block M12 where data of the alarm thresholds, the calculation parameters, the diagnosis parameters of the optical transceiver 10, the preset password afore mentioned, an index data for the extension block are stored. Half of the block M12 is prepared for a user rewritable area and for another vendor specific data. The host device 20 may write the password in the area PW through the I²C bus 30 by setting the slave address A2h. Rewriting the password, the CPU 101 changes the security level thereof to “privileged level”.

In “privileged level”, the controller 1 may respond to the host device 20 by sending ACK when the controller 1 receives the slave addresses A4h and A6h in addition to A0h and A2h. The slave addresses A4h and A6h are the extended slave addresses which are defined to be unusable because the multi source agreement of one type of the optical transceiver 10 allows only two slave addresses, A0h and A2h. According to the standard of the I²C bus, the optical transceiver 10 connected to the I²C bus 30 may respond the master device, the host device 20 in the present embodiment, by sending ACK thereto; then, the host device 20, independent on other devices connected to the same I²C bus 30 may distinguish a target optical transceiver 10. Similar to the state of “unprivileged level”, the host device 20 subsequently sends the memory address with READ/WRITE mode flag to the controller 1. The present embodiment defines only two extended slave addresses, A4h and A6h; however, the invention may define only one extended slave address or more than two extended slave addresses.

The controller 1 accesses the EEPROM 11 based on the received slave address with the operation mode flag and the specific memory address. When the received slave address is A0h or A2h, the controller 1 accesses the block M10 or M12; while, when the received slave address is A4h or A6h, then the controller may access other blocks, M24 or M26, where areas, MA1 to MA3, for data referred and used in the production of the optical transceiver 10 are defined.

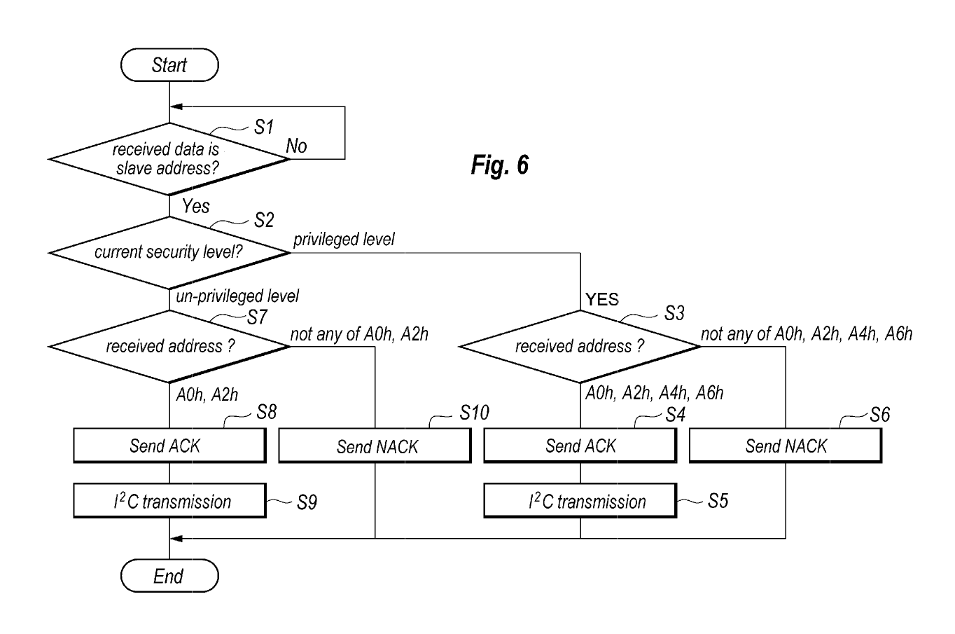

Next, the sequence of the operation depending on the security level will be described as referring to FIG. 6 which is a flow chart showing the sequence of the serial interface. The controller 1, specifically the SPI 104 thereof, watches what slave address is on the I²C bus 30, which is denoted as step S1. When a data on the I²C bus is a type of the slave address, the CPU subsequently checks the current security level at step S2. When the current security level is “privileged level”, the slave address on the bus 30 which the optical transceiver 10 is necessary to respond thereto is one of A0h to A6h, the CPU 101 checks the slave address received at step S2 is one of those addresses, at step S3; and sends ACK on the bus 30 when the received slave address is one of those addresses, at step S4. Subsequently, the controller 1 advances the protocol of the I²C bus, namely, sending and receiving data and addresses with respect to the host device 20 at step S5. On the other hand, when the slave address received at step S1 is not any of those addresses, the controller 1 sends NACK on the I²C bus 30 at step S6.

When the current security level is “unprivileged level”, the controller 1 checks the slave address received at step S1 is one of A0h and A2h at step S7. In a case the received slave address matches one of two addresses, A0h and A2h, the controller sends ACK to the host device 20 at step 8 and advances the sending/receiving data/addresses according to the I²C protocol with respect to the host device 20 at step S9. On the other hand, the received slave address is not any of two addresses, A0h and A2h, the controller 1 sends NACK on the bus 30 at step S10.

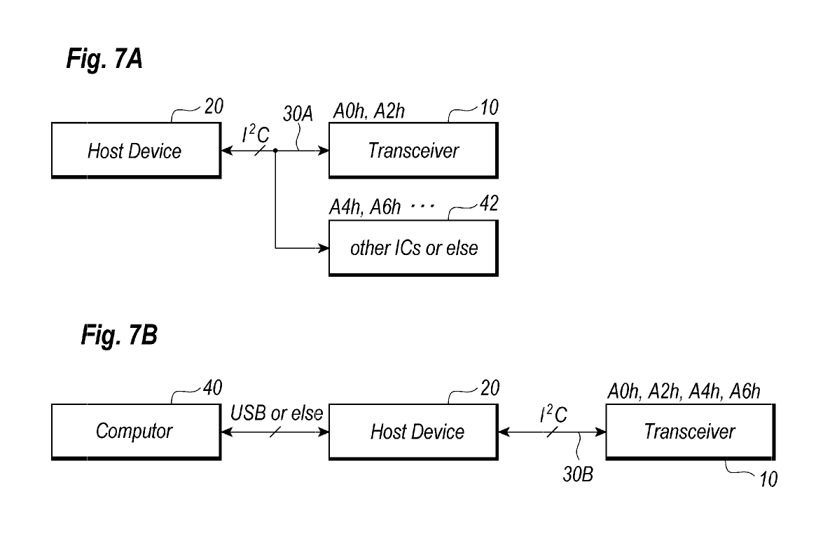

Next, an exemplary configuration for the optical transceiver according to the present will be explained as referring to FIGS. 7A and 7B. FIG. 7A schematically shows an arrangement where the optical transceiver 10 is implemented within a system including the host device 20, while, FIG. 7B schematically shows another arrangement when the optical transceiver 10 is in a production or in a delivery inspection.

As shown in FIG. 7A, the optical transceiver 10 is coupled with the host device 20 which behaves as the master device on the I²C bus 30A, and are assigned with two slave addresses A0h and A2h in default. The I²C bus 30A connects, in addition to the optical transceiver 10, with other devices of ICs or the like 42 each being assigned with a slave address, A4h, A6h, and so on, specific to the IC. Accordingly, when the optical transceiver 10 replies ACK for the slave addresses except for A0h and A2h, specifically, when the transceiver 10 sends ACK to the slave address A4h, the address collision or the collision of ACK will be caused between the optical transceiver 10 and the other IC 42. Moreover, because the extended blocks, MA1 to MA3, stores data and information used in the production or the delivery inspection of the optical transceiver 10, it would be preferable that a field user or a customer is unable to access those extended blocks during the practical operation of the transceiver 10. Thus, the optical transceiver 10 should be kept in “unprivileged level” when it is implemented in the practical system.

On the other hand, during the production or the delivery inspection of the transceiver 10 shown in FIG. 7B, the transceiver 10 is coupled with the host device 20 through the I²C bus, while, the host device 20 is coupled with a computer such as a personal computer 40 through a cable with the USB standard. Thus, the production or the delivery inspection may be carried out by controlling the host device 20 with the personal computer 40. In this case, because the I²C bus 30B couples no devices other than the transceiver 10, no address collision may be occurred even if the host device 20 sets slave addresses other than those, A0h and A2h, defined in the specification of the optical transceiver and the optical transceiver 10 replies those slave addresses by setting ACK on the bus 30B. The host device 20 may access the optical transceiver by setting the slave address such as A4h, A6h and the like, and may rewrite the extended blocks MA1 to MA3 through the controller 1 in the optical transceiver 10.

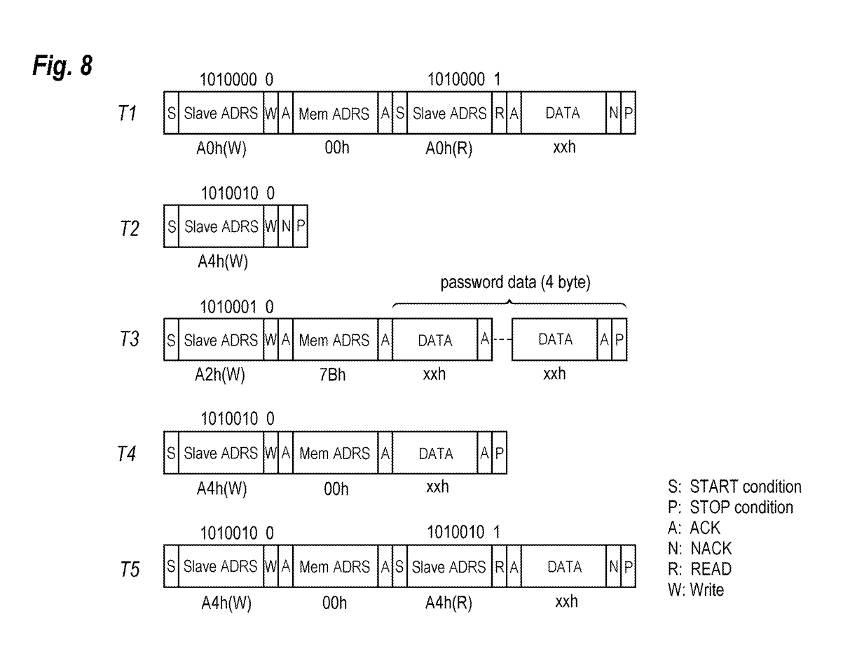

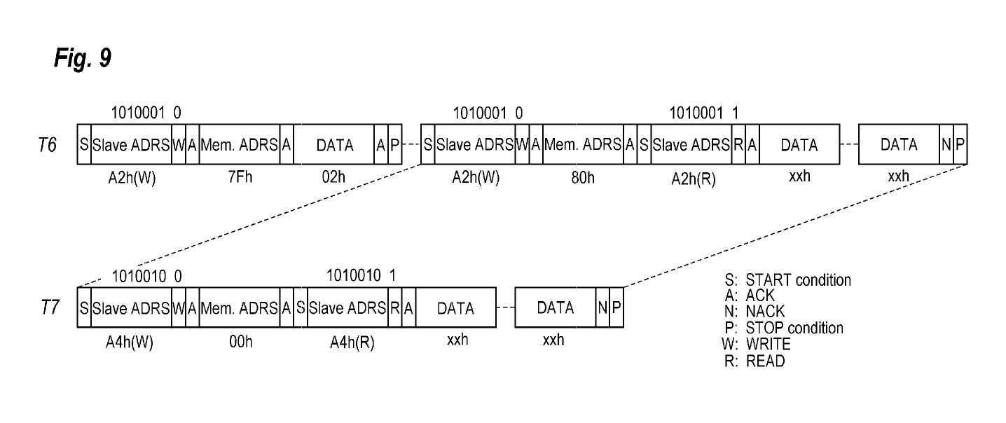

Next, details of the protocol of the I²C bus 30 implemented with the optical transceiver 10 will be described as referring to FIGS. 8 and 9. FIG. 8 shows data stream on the I²C bus 30 when the security level of the optical transceiver 10 changes from the “unprivileged level” to “privileged level”. Symbols S, A, N, P, W and R appeared in FIGS. 8 and 9 indicate the status of START CONDITION, ACK, NACK, STOP CONDITION, WRITE, and READ, respectively, defined in the I²C protocol.

The first chart T1 shows data stream on the I²C bus 30 when the host device 20 fetches the data stored in the address 00h in the base block M10. The host device 20 first sets, as the master device 10, the slave address A0h with the access mode flag, where the access mode means that the data set on the I²C bus subsequent to the slave address is transmitted from the master device to the slave device (WRITE mode) or from the slave device to the master device (READ mode), and the least significant bit (LSB) of the slave address distinguishes this mode, namely, the reset of the LSB means the mode is WRITE; while, the set of the LSB means the mode is READ. In the I²C protocol, 8 bits data subsequent to the start condition flag S corresponds to the slave address with the mode flag; accordingly, the slave devices connected to the I²C bus may acknowledge the slave address. One of the slave devices whose slave address is identical with the address set on the bus immediately responds thereto by setting ACK on the bus. The host device 20 confirms ACK from the slave device which means that at least one slave device whose address is identical with the address just set on the bus exists on the bus, and subsequently sets the specific memory address 00h which indicates the memory address to be accessed in READ mode. After setting ACK by the transceiver 10 responding to the set of the memory address 00h, the transceiver 10 prepares a data stored in the address 00h of the block M10.

The host device 20 again sets the slave address of A0h with READ mode flag after START condition flag, and the transceiver 10 responds to the host device 20 by setting ACK and the data stored in the address 00h and prepared in advance to the second reception of the slave address. The address and the data are set on the I²C bus in series from the most significant bit (MSB) to the LSB.

The second chart T2 shows a sequence when the host device 20 sets the slave address A4h and no slave device responds to the host device 20. Because the optical transceivers 10 begins the operation thereof in “unprivileged level, the transceiver 10 does not set ACK on the I²C bus responding to the address A4h with WRITE mode flag, but sets NACK on the bus.

The third chart T3 corresponds to a sequence to write a password in the area PW to change the security level of the transceiver 10 to “privileged level”. The host device 20 first sets, subsequent to the START condition flag, the slave address A2h with WRTIE mode flag, and the optical transceiver 10 responds by setting ACK. Subsequently, after confirming the ACK on the bus, the host device 20 sets the specific memory address of 7Bh on the bus. The address 7Bh corresponds to the area PW in the block M12 as shown in FIG. 4. The host device 20 subsequently sets the new password data with 4 bytes on the bus. The password data continues until the transceiver 10 receives STOP condition flag.

The fourth chart T4 corresponds to a sequence where the host device 20 refers the extended block M24 shown in FIG. 5 by setting the slave address of A4h on the bus. Setting the slave address A4h with the WRITE mode flag on the bus subsequent to START condition flag by the host device 20, the optical transceiver 10 responds thereto by setting ACK. Thus, the optical transceiver 10 may respond to the slave address A4h different from the sequence T2 in which NACK is set on the bus in the “unprivileged level”. The host device 20 subsequently sets the specific memory address 00h on the bus and the data to be written in the specific address 00h sequentially. The optical transceiver 10 fetches the address 00h and the data in series, and practically access the extended block M24.

The fifth time chart T5 shows a sequence in which the host device 20 receives a data stored in the address 00h of the extended block M24. The host device 20 first sets the slave address A4h with the WRITE mode flag on the bus, then, the optical transceiver 10 responds thereto by setting ACK. The host device 20 next sets the specific memory address 00h on the bus, and the transceiver 10 responds thereto by setting ACK again. After setting ACK, the transceiver 10 prepares the data stored in the address 00h before receiving the next slave address. The host device 20, by receiving ACK of the memory address 00h, sets START condition flag and the target slave address A4h with the READ mode flag. Then, the transceiver 10 replies the slave address A4h by setting ACK and sets the data stored in the address 00h on the bus. The transceiver 10 finally asserts NACK and STOP condition flag on the bus to terminate the data transfer.

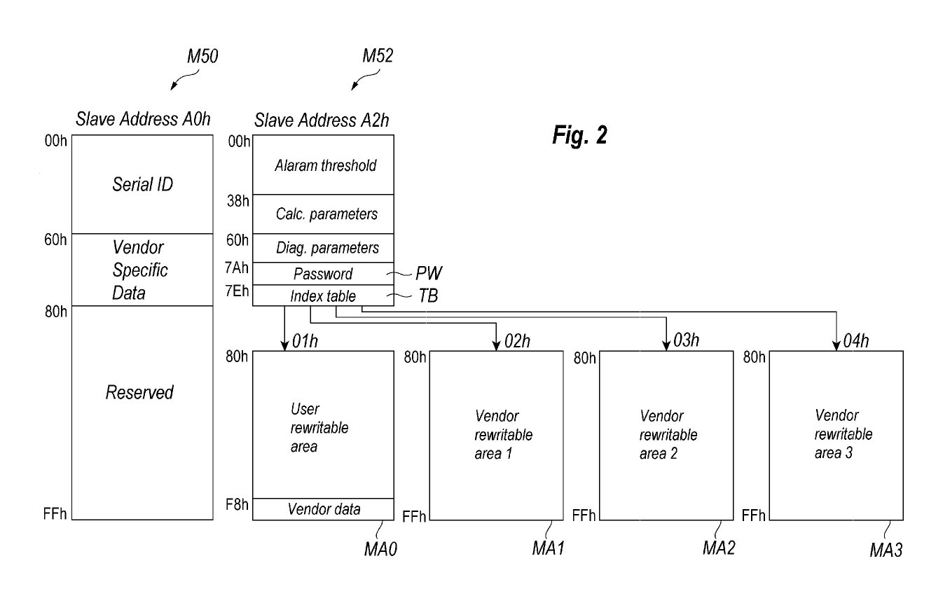

FIG. 9 shows a sequence T6 to access the extended block MA1 by a conventional transceiver 50 shown in FIG. 1, where the memory map of the extended block MA1 is shown in FIG. 2; while, FIG. 9 is a sequence T7 to access the extended block MA1 shown in FIG. 5 performed by the optical transceiver 10 according to the present embodiment.

The conventional transceiver 50 accesses the extended blocks, MA1 to MA3 by first setting one of the indices, 01h to 04h, in the address TB of the second block M52. Accordingly; the sequence T6 shown in FIG. 9 first sets the slave address A2h with WRITE mode flag subsequent to START condition flag, secondly sets the specific address of 7Fh corresponding to the area TB, and lastly sets an index data 02h to be written in the area TB. The optical transceiver 50 writes the data 02h to the address 7Fh in the area TB, and the optical transceiver may subsequently access the extended block MA1.

Next, the host device 20 sequentially sets the slave address A2h with WRITE mode flag and the specific address 80h. Then, the optical transceiver 50 prepares to write data which are to be sent subsequently in addresses beginning from 80h. Setting the slave address A2h with WRITE mode flag and a set of data subsequent to the slave address A2h, the optical transceiver 50 may store those sent data from the address 80h in the extended block MA1 until STOP condition flag P is detected.

On the other hand, in the optical transceiver 10 of the present embodiment, as illustrated in FIG. 9, it is unnecessary to preset the index data in the area TB of the base block MA0. Accordingly, the host device 20 firstly sets the slave address A4h with WRITE mode flag and the memory address 00h subsequent to the slave address. Then, the optical transceiver 10 may acknowledge the start address from which a set of data is to be stored. Setting the slave address A4h again but with READ mode flag, the optical transceiver 10 transmits a set of data sequentially read from the address 00h of the extended block MA1 to the host device 20. Thus, comparing the sequence performed by the conventional optical transceiver 50, the transceiver 10 according to the present embodiment may omit the prosecution cycle and shorten the prosecution period for accessing the extended block.

Accordingly, the optical transceiver according to an embodiment of the invention may change the security level thereof from “unprivileged level” to “privileged level” by rewriting a new password in the address PW. The master device may access the extended memory through the controller 1 by setting an extra slave address such as A4h, A6h and so on which is unable to access in “unprivileged level”. Thus, the address space may be equivalently expanded in “privileged level”. The access to the extended space is unnecessary to preset any index data in the area TB, and may be realized in a same manner with those to the base blocks of the memory. Thus, the access time for the extended memory may be shortened.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A pluggable optical transceiver communicating with a host device through a serial interface, comprising:
a TOSA;
a ROSA;
a transceiver circuit including a driver to drive said TOSA, a limiting amplifier to amplify a signal from said ROSA; and
a controller to control and monitor said transceiver circuit, said TOSA and said ROSA, said controller including said serial interface, a memory with a base block and an extended block, and a CPU,
wherein said optical transceiver has a first security level and a second security level thereof, said extended block of said memory being accessible only in said second security level.

2. The optical transceiver of claim 1,
wherein said memory provides a password area in said base block, and
wherein said optical transceiver changes said security level thereof from said first level to said second level when said password area is rewritten.

3. The optical transceiver of claim 1,
wherein said serial interface is an I²C bus, and
wherein said base block corresponds to one of slave addresses of said I²C bus inherently assigned to said optical transceiver, and said extended block corresponds to another slave address ordinarily not assigned to said optical transceiver.

4. The optical transceiver of claim 3,
wherein said optical transceiver responds to said other slave address only when said optical transceiver is specific in said second security level.

5. The optical transceiver of claim 1,
wherein said extended block of said memory stores data used only in a production and a delivery inspection of said optical transceiver.

6. A method to control a pluggable optical transceiver communicating with a host device through an I²C serial bus, said method comprising steps of:
setting a slave address inherently assigned to said optical transceiver, a specific memory address allocated in a base block of a memory installed in said optical transceiver, and a data to be rewritten in said memory address sequentially on said serial bus;
changing security level of said optical transceiver from an unprivileged level to a privileged level; and
setting another slave address not inherently assigned to said optical transceiver, another memory address allocated in an extend block of said memory, another data to be rewritten in said other memory address sequentially on said serial bus.

7. A method to produce a pluggable optical transceiver including a controller with a serial interface and a memory therein, said serial interface communicating with a serial bus, said method comprising steps of:
setting a slave address inherently assigned to said optical transceiver, a specific memory address that is allocated in a base block of said memory, and a data to be rewritten in said specific memory address sequentially on said serial bus;
changing a security level of said optical transceiver from an unprivileged level to a privileged level by rewriting said data in said specific memory address; and
setting another slave address not inherently assigned to said optical transceiver, another memory address allocated in an extend block of said memory, another set of data to be rewritten in said other memory address sequentially on said serial bus,
wherein said another set of data is used in said production of said optical transceiver.

8. The method of claim 7,
wherein said another set of data is used in a delivery inspection of said optical transceiver.
